(19) United States
(12) Patent Application Publication
(10) Pub. No.: US 2020/0049285 A1
(43) Pub. Date: Feb. 13, 2020

(54) PIPE COUPLING

(71) Applicant: ALTURA MANUFACTURING, LLC, ODESSA, TX (US)

(72) Inventor: LINDSEY LEE, HOUSTON, TX (US)

(21) Appl. No.: 16/059,808

(22) Filed: Aug. 9, 2018

(51) Int. Cl. F16L 23/08; F16L 17/04; F16L 21/02

(52) U.S. Cl. CPC F16L 23/08; F16L 21/02; F16L 17/04

(57) ABSTRACT

A pipe coupling for connecting grooved pipe components in end-to-end relationship has a stepped retainer key. The stepped retainer key has a lead portion and a retainer portion. The lead portion is angularly offset from vertical to a greater degree than the retainer portion.

### BACKGROUND

In the oil field and in other applications in which fluid flow is controlled and directed, there are a number of types of pipe couplings that are utilized. One type of coupling is that which utilizes flanges to engage grooves in pipes that are to be coupled together in end-to-end relation. Oftentimes, the connections are made in the field and as a result couplings that are easily received in the pipe coupling and that will retain the grooved pipe couplings in end-to-end relationship are used. The current disclosure is directed to a coupling that has a stepped retainer key such that it is easily inserted into grooves in a grooved pipe and will securely hold pipe components in a coupled end-to-end relationship.

### SUMMARY

The current disclosure is directed to a pipe coupling configured to connect pipe components in end to end relationship. In one embodiment, the pipe coupling includes a pair of coupling segments configured to engage grooved pipe components to couple the pipe components together. The coupling segments may comprise an arcuate body with first and second ends. First and second bolt pads extend from the first and second ends of the arcuate body and the first and second bolt pads define fastener openings therethrough for receiving a fastening member to connect the coupling segments and couple the pipe components.

In one embodiment a fastener engagement surface defined on the first and second bolt pads is inclined relative to a horizontal plane such that the head of a fastening device inserted through the fastener openings will apply a greater clamping force on a inner portion of the fastener engagement surface that is located radially inwardly from a center line of the fastener opening than is applied to a portion of the fastener engagement surface that is located radially outwardly from the centerline.

The arcuate body of the coupling segment comprises a channel configured to receive a sealing element. The sealing element comprises a generally u-shaped body with a base and legs extending therefrom. A gasket shield may be included in the space between the legs of the seal. The channel is defined by an annular channel surface and a pair of flanges extending from annular channel surface. The flanges comprise first, or lower, and second, or upper portions and the upper portion comprises a retainer lip configured to be received in the grooves defined in the pipe components to be coupled together.

In an additional embodiment, the flange includes a retainer lip with a lead portion and a retainer portion. The lead portion and retainer portion are angularly offset from a vertical plane, and the lead portion is offset to a greater degree than the retainer portion. In one embodiment the lead portion is offset in the range of 20 degrees to 35 degree and the retainer portion is offset in the range of about 2 degrees to about 10 degrees. The retainer lip thus defines a lead angle and a retainer angle and the lead angle is greater from the retainer angle. The lead angle may be for example in the range of about 20 degrees to about 35 degrees, and the retainer angle in the range of about 2 degrees-10 degrees. In some embodiments a seal is received in the channel.

The coupling segments comprise a pair of bolt pads defining bolt openings therethrough which are configured to receive bolts to connect the first and second coupling segments together. In one embodiment, the bolt pads comprise fastener engagement surfaces that are angularly offset from a horizontal plane. The fastener engagement surfaces may be angularly offset in the range of about 2 degrees to about 5 degrees from the horizontal. In an additional embodiment bolt head and nuts tightened into the fastener engagement surface will apply a greater clamping force on a portion of the engagement surface located radially inwardly from a line bisecting the fastener opening than on a portion of the fastener engagement surface located radially outwardly therefrom.

In another embodiment a pipe assembly comprises first and second grooved pipe components and a coupling connecting the first and second grooved pipe components in an end to end relationship. The coupling comprises first and second arcuate coupling segments. The coupling segments comprise a channel, and the channel is defined by an annular channel surface and first and second flanges extending therefrom.

A retainer lip is defined on the flanges and is configured to be received in grooves on the first and second grooved pipe components. The retainer lip has a stepped inner surface. The stepped inner surface defines a lead portion at the leading edge of the retainer lip and a retainer portion extending from the annular channel surface. The lead portion extends from and is angularly offset from the retainer portion. In one embodiment, a lead angle defined by the lead portion is greater than a retainer angle defined by the retainer portion. The lead angle may be for examples in the range of about 20 degrees to 35 degrees and the retainer angle is in the range of about 2 degrees to about 10 degrees.

### BRIEF DESCRIPTION OF THE DRAWINGS

FIG. 1 is perspective view of a coupling segment.

FIG. 2 is a top view of pipe components joined by couplings disclosed herein.

FIG. 3 is an exploded view showing coupling segments and the pipe to be joined.

FIG. 4 is a cross section in the direction of lines 4-4 of FIG. 2, without the pipe components.

FIG. 5 is a cross section in the direction of lie 5-5 of FIG. 2.n enlarged view of a bolt pad.

FIG. 6 is an enlarged view of a bolt pad in cross section.

FIG. 7 is an enlarged view of a bolt pad in cross section.

FIG. 8 is an enlarged view in cross section of a retainer lip.

FIG. 9 is an enlarged view in cross section of a retainer lip.

FIG. 10 is an enlarged view of a seal with gasket shields.

FIG. 11 is an enlarged view of an additional embodiment of a seal with a gasket shield.

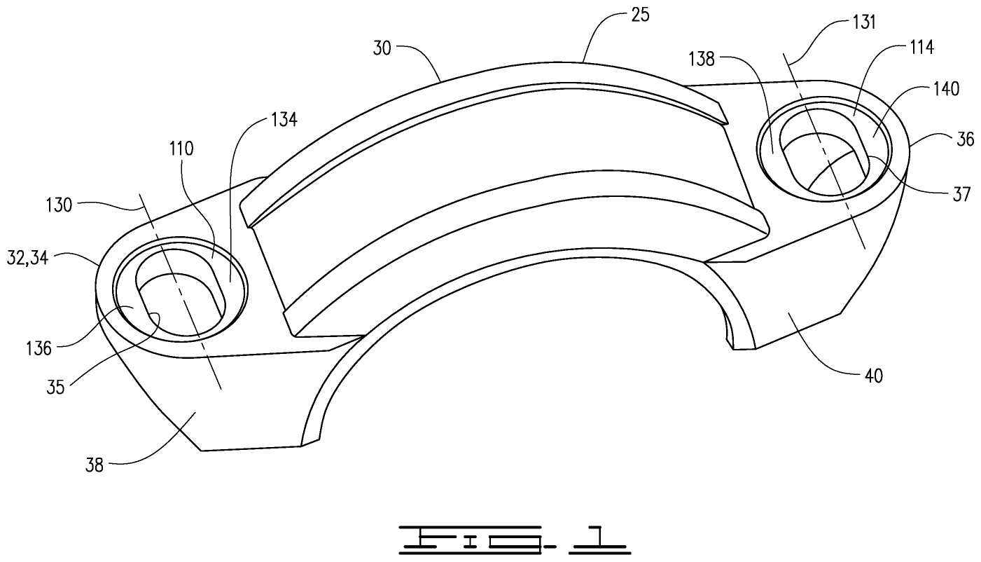

### DETAILED DESCRIPTION

Referring now to the drawings a coupling 10 for connecting grooved pipe components 15 in an end-to-end relationship is disclosed. Grooved pipe components 15 have pipe ends 16, and define grooves 20 therein in which coupling 10 is received to couple pipe components 15 together.

Coupling 10 comprises a pair of coupling segments 25 which may be arcuate coupling segments 25. For ease of description, the pair of coupling segments will be referred to as coupling segments 25 and 25a, and it is understood that the coupling segments 25 and 25a are substantially identical.

Arcuate coupling segment 25 includes a body 30, which may be an arcuate body 30. Bolt pads 32 extend radially outwardly from arcuate body 30 and comprise a first bolt pad 34 and second bolt pad 36. Bolt pads 34 and 36 define bolt openings 35 and 37 respectfully. Bolt openings 35 and 37 are elongated openings. Reinforcing shoulders 38 and 40 respectively connect bolt pads 34 and 36 to arcuate body 30. To provide for ease of description, x, y and z axes are identified in the FIGS. The x-direction as depicted in FIG. 4 is horizontal, and a horizontal plane defined by the z axis and the x axis vertically bisects the coupled segments 25. The y direction is vertical and a plane defined by the y axis and the z axis bisects each coupling segment. The z-direction is shown in FIG. 5, and a plane defined by the z axis and the x axis bisects the coupled pipes, and the z axis is longitudinal central axis of the pipe components 15. The terms vertical and horizontal are used herein with reference to the position and orientation of the couplings as shown in the drawings.

Because coupling segments 25 and 25a are identical, the features of each will be described primarily with respect to coupling segment 25. Each coupling segment 25 defines a channel 49. Channel 49 is defined by a pair of opposed upstanding flanges 50 which may comprise first and second flanges 52 and 54. An annular channel surface 56 extends between flanges 52 and 54. Channel 49 is a generally U-shaped channel. Flanges 52 and 54 extend from annular channel surface 56 to define channel 49.

Arcuate body 30 has ends 58 and 60 respectively. End 58 defines a U-shaped recess 62 and end 60 defines a generally U-shaped tongue 64. Thus, when combined or connected, couplings 25 and 25a co-act in the same manner as a tongue and groove connection. In other words as shown in FIG. 4, coupling segment 25a will be rotated 180 degrees such that the u-shaped tongue 64a rests in u-shaped recess 62 while u-shaped tongue 64 will rest in u-shaped recess 62a. Coupling segments 25 have outer surface 66.

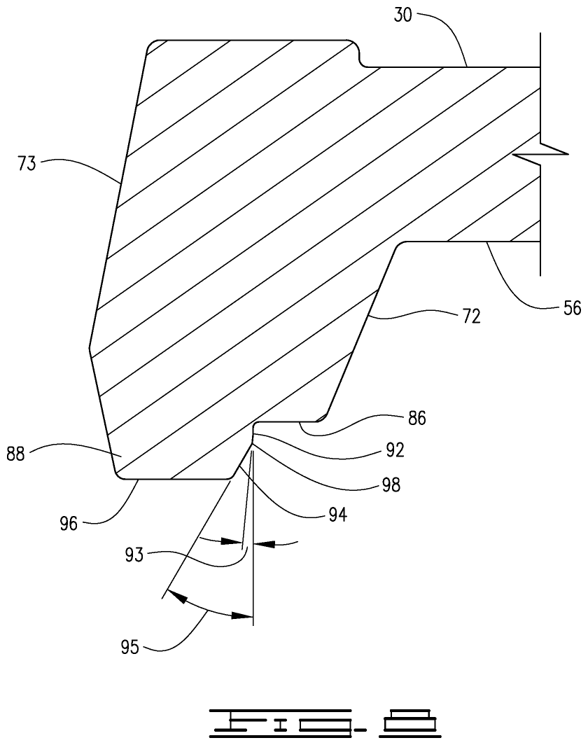

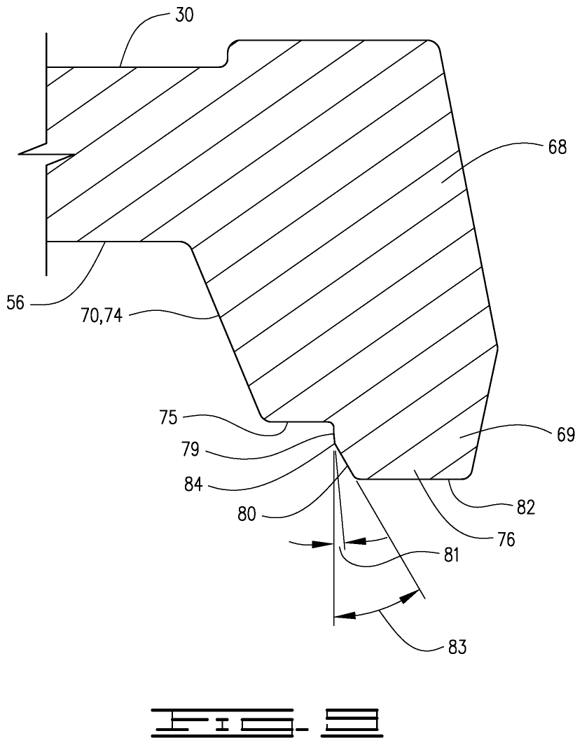

Flange 52 has first and second portions 68 and 69. Flange 54 has first and second portions 71 and 73. Flange 52 has inner surface 70 and flange 54 has inner surface 72. Inner surface 70 has a first portion 74 corresponding to first portion 68 of flange 52 that extends from annular surface 56 to a flat 75, which is a generally horizontal flat. A second portion of surface 70 corresponding to second portion 69 of flange 52 extends from flat 75, and defines retainer lip 76. Retainer lip 76 may be referred to as a retainer key 76. Flat 75 is generally horizontal. Inner surface 70 on retainer lip 76 is a stepped inner surface 78, thus defining a stepped retainer lip 76. Stepped retainer lip 76 has a lead portion 80 and a retainer portion 79. Retainer portion 79 defines a retainer angle 81 and lead portion 80 defines a lead angle 83. Retainer angle 81 and lead angle 83 are offset from the vertical as depicted in FIGS. 8 and 9, and lead angle 83 is greater than retainer angle 81. Retainer angle 81 is in the range of about 2°-10° from the vertical as depicted in FIGS. 8 and 9. In other words, retainer angle 81 is in angularly offset the range of about 2 degrees-10 degrees from a vertical plane that laterally bisects the coupling segments 25 and 25a. Lead angle 83 may be for example in the range of 20 degrees to 35 degrees. Retainer portion 79 extends upwardly from flat 75, and terminates at a break point 84. Lead portion 80 extends from break point 84 and terminates at annular end surface 82. Retainer portion 79 and lead portion 80 are thus angularly offset from the vertical, and lead portion 80 is offset to a greater degree than retainer portion 79.

Inner surface 72 on flange 54 extends from annular channel surface 56 up to a flat 86. A retainer lip 88 extends from flat 86. Retainer lip 88 which may be referred to as a retainer key 88, has a stepped inner surface and thus has a retainer portion 92 defining a retainer angle 93 and a lead portion 94 defining a lead angle 95. Lead portion 94 terminates at annular end surface 96 of flange 54. The transition between retainer portion 92 and lead portion 94 is at break point 98. The angles are measured from the vertical plane as described with respect to flange 52. Lead angle 95 is greater than retainer angle 92. For example, lead angle 95 may be in the range of about 20 degrees to 35 degrees and retainer angle 93 in the range of about 2 to 10 degrees. Retainer portion 92 and lead portion 94 are thus angularly offset from the vertical, and lead portion 94 is angularly offset to a greater degree than retainer portion 92. Because flanges 52 and 54 include stepped retainer lips, the flanges will pop into grooves 20 more easily than standard couplings, and will still retain the pipe components in a connected relationship. The design of the current disclosure is an improvement in terms of safety and structural integrity over the current design. The lead angle is great enough such that coupling segments 25 and 25a will easily pop into grooves 20 in grooved pipe components 15. Because the retainer lips 76 and 88 include retainer portions which have less angular offset than the lead portions, coupling segments 25 and 25a when pulled together will hold pipe components 15 together and secure the components in end-to-end relationship. With prior art couplings the retainer lip is not stepped and is generally at about a 5 degree angle. Often times the coupling is difficult to properly fit during field installations. As a result damage can sometimes occur during use. The invention of the current disclosure remedies the problem by providing the lead portion with a lead angle large enough to allow an easy installation and proper fit. The nearly 90 degree retainer portion of the retainer lip results in a lower wedge effect which acts to better grab or retain the coupling.

Referring now to FIG. 5, a seal, or gasket 100 is received in channels 49 and 49a. Seal 100 includes a seal body 102 and a tongue 104 extending therefrom. Seal body 102 is a general u-shaped body with a base 105 and legs 107 extending therefrom. Sealing feet 109 extend inwardly from legs 107. Sealing feet 109 will engage and seal against pipe components 15 in an assembly including coupling 10 and pipe components 15. Gasket cut shields 103 are positioned in an interior space defined between the legs 107, and in the embodiment of FIG. 5 there are two gasket shields 103 positioned on either side of the tongue 104. The gasket cut shields will serve to prevent damage to the seal 100 during installation, and when vacuum pressure tests are conducted on a pipe assembly. Tongue 104 will extend into the space between the connected grooved pipe components 15. Although the seal shown in the described embodiment includes a tongue, it is understood that seals without a tongue may be used as well.

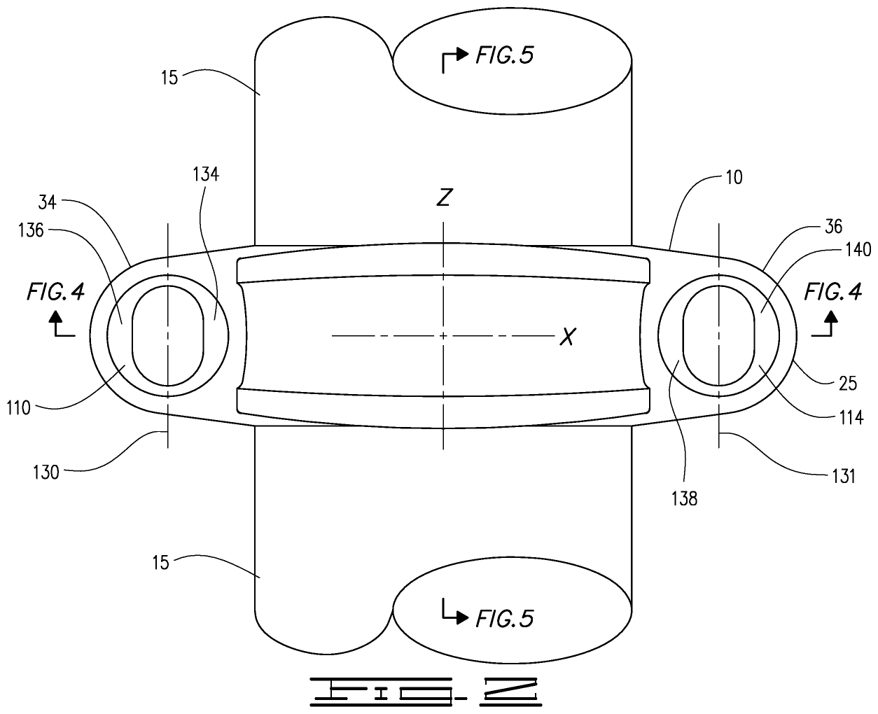

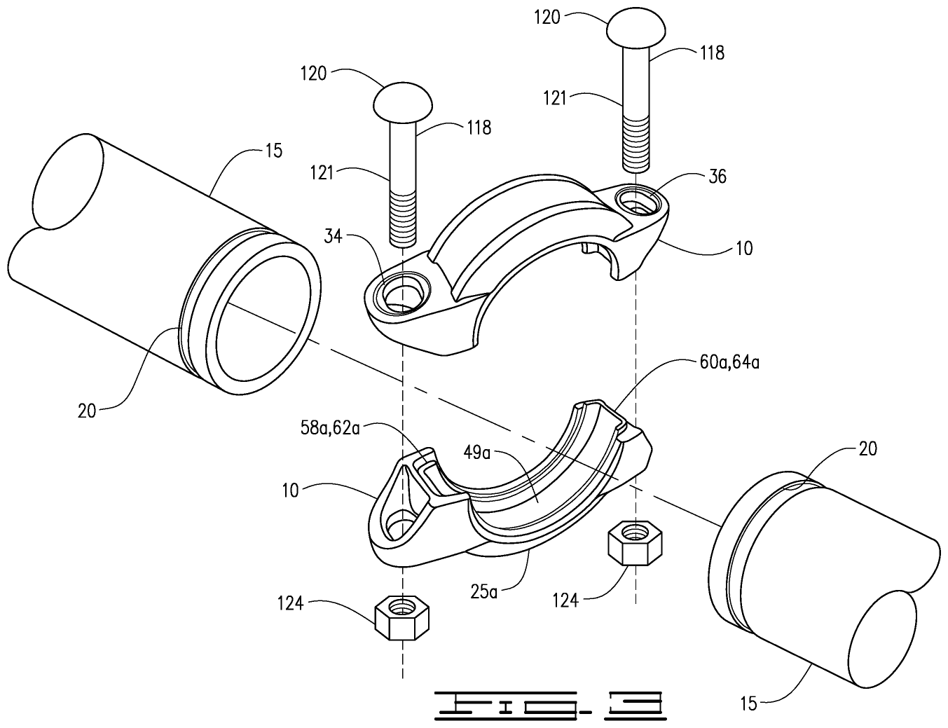

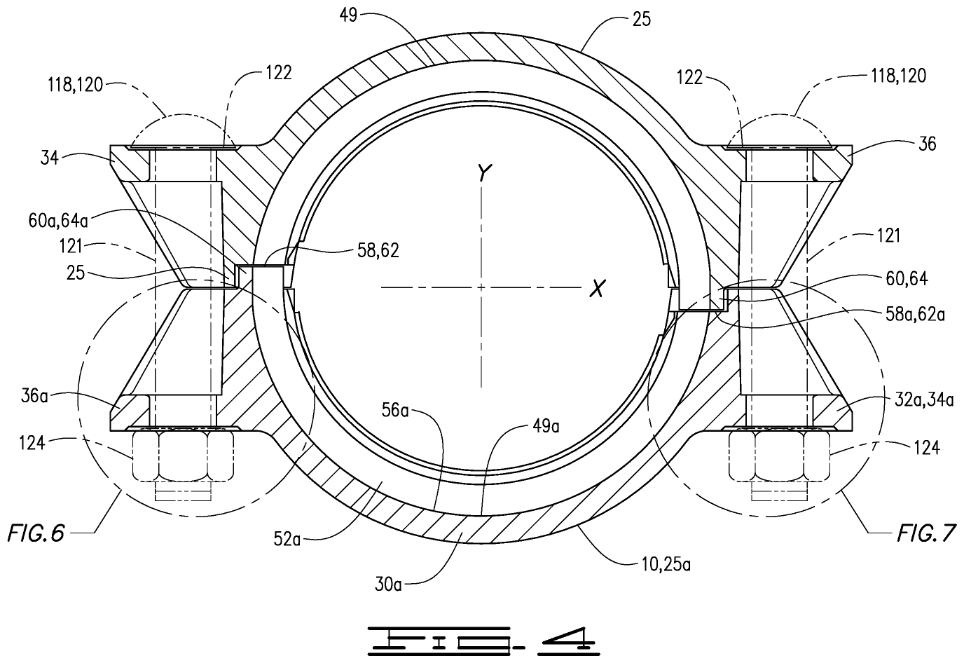

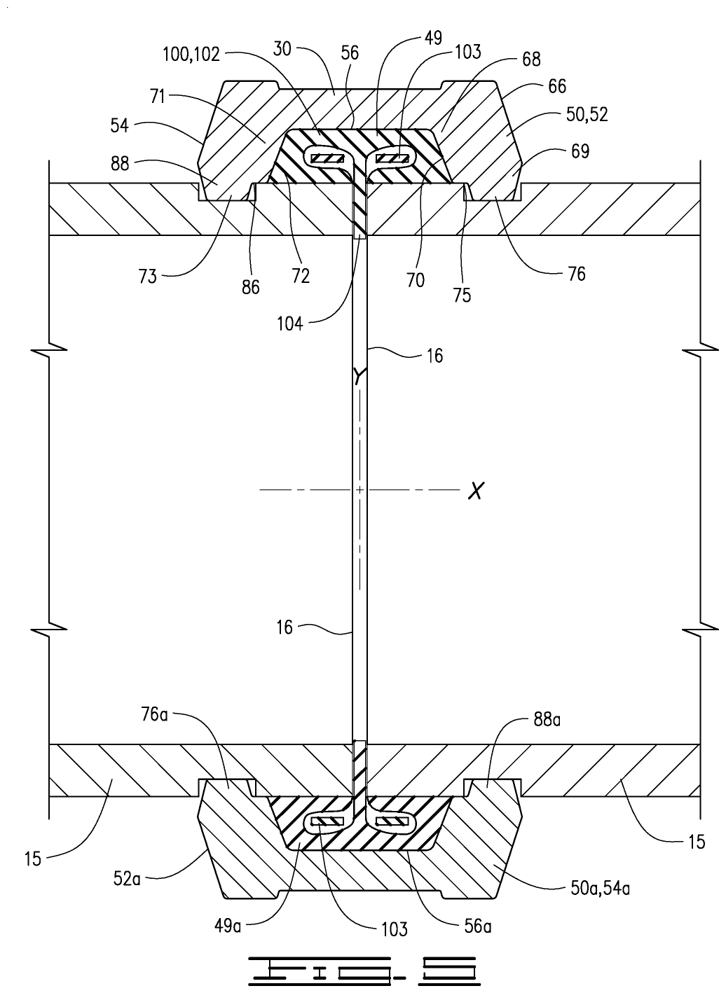

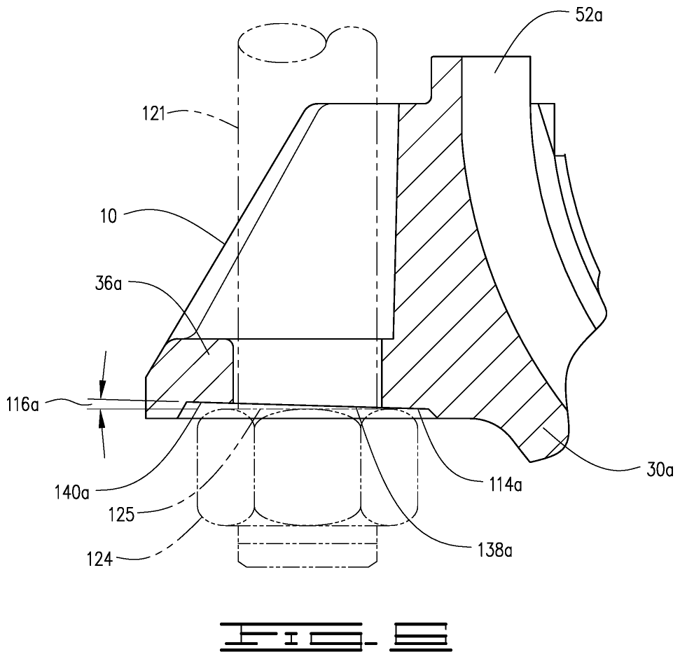

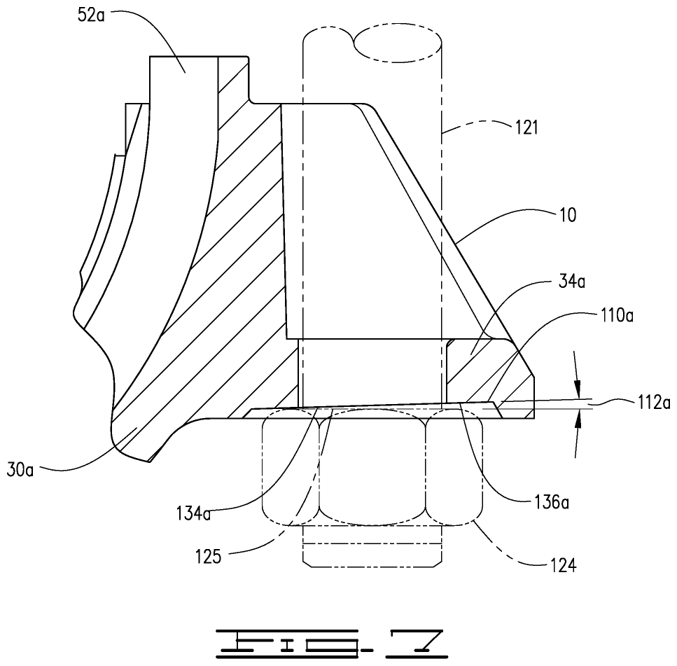

Bolt pads 34 and 36 include engagement surfaces 110 and 114, respectively. Engagement surface 110 is oriented at an angle 112 from the x axis as shown in FIG. 4. Engagement surface 114 is oriented at an angle 116 from the from the x axis as shown in FIG. 4. Thus, surfaces 110 and 114 are angularly offset from the horizontal, and more specifically are angularly offset from the plane defined by the x and z axes. Bolts 118 with a bolt head 120 and shaft 121 are inserted through bolt openings 35 and 37. A nut 124 is threaded onto the end of shaft 121. As a result of the angular offset of engagement surfaces 110 and 114, the engagement surfaces 122 of bolt head 120 and 125 of nut 124 will engage surfaces 110 and 114 on a radially inward portion of fastener engagement surfaces 110 and 114 to a greater degree than on the radially outward portion thereof. The radially inward portion is located radially inwardly from a center line in the direction that bisects fastener engagement surface 110 and 114. As shown on FIG. 2, bisecting center lines 130 and 131 bisect each of engagement surfaces 110 and 114. Engagement surface 110 has first or radially inward portion 134 and second, or radially outward portion 136. Engagement surface 114 has first, or radially inward portion 138 and second, or radially outward portion 140. Because the bolt head and nut engage on the radially inward portion of engaging surfaces 110 and 114 a greater clamping force is applied thereon than is applied to the radially outward portion of the engagement surfaces. In some instances, there may be no clamping force applied to the radially outward portions. The impact of this is to shorten what is essentially a beam length between the center of the coupling and the force location, and thus less bending force is applied to the coupling. The exploded views of FIGS. 6 and 7 show the engagement surfaces on the nut side of the connection, and it is understood that the identical arrangement exists on the bolt head side of the connection.

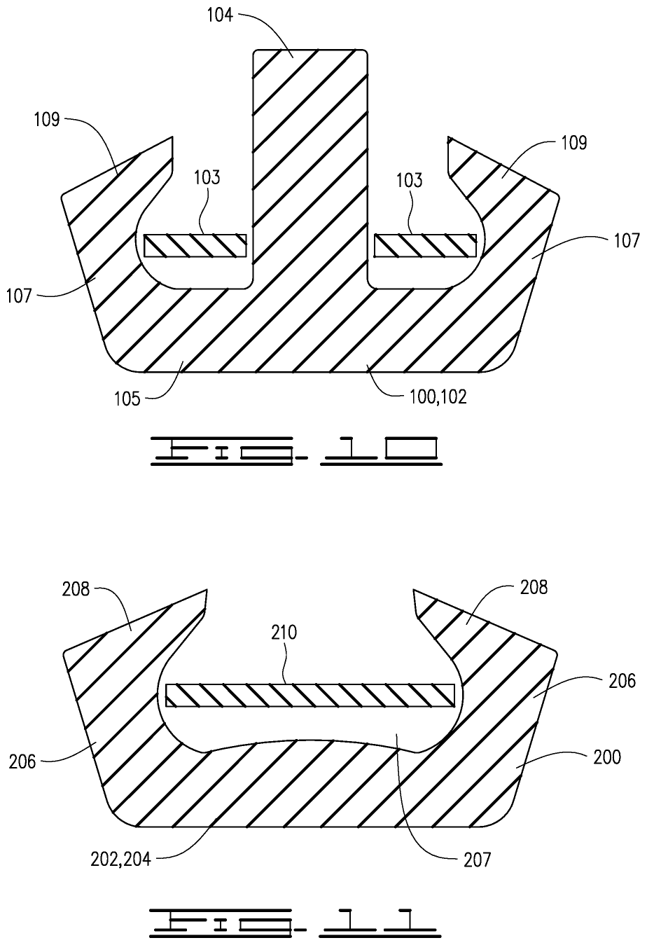

In the embodiment of FIG. 10 the seal or gasket 100 includes a tongue. The seal 100 is shown in an unrestrained or uninstalled state in FIG. 10. Gasket cut shields 103 are designed to prevent damage to the gasket 100. It is well known that pipe is often cut in the field, and that as a result, the pipe ends may have nicks, or burrs thereon that can come into contact with seal body 102 and can result in a failure. For example, at various times it may be necessary to vacuum test a pipeline. During a vacuum test, the base 105 of a seal 100 in a pipe assembly may be pulled toward the pipe surface, and may contact burrs, nicks or sharp edges on pipe ends 16, causing damage to the seal 100. The damage can cause a failure to the seal 100, which can ultimately cause a failure at the connections of the coupling and the connected pipes 15. As described above, gasket shields 103, which are annular gasket shields will protect seal 100 during installation and vacuum testing.

FIG. 11 shows an embodiment of a seal or gasket 200 that may be used with the coupling described herein. The seal 200 is shaped generally like seal 100, but does not have a tongue. Seal 200 has a seal body 202, which is a generally U-shaped body with base 204 and legs 206 extending therefrom. A space 207 is defined between legs 206. Feet 208 extend inwardly from legs 206, and will engage coupled pipes 15 as described with respect to seal 100. A gasket shield 210, shown in cross section in FIG. 11, which is an annular gasket shield, is positioned in space 207. Gasket shield 20 protects seal 200 and in particular seal base 204, in the same manner as described with respect to gasket shields 103 for seal 100.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A pipe coupling comprising:
a pair of coupling segments configured to engage grooved pipe components to couple the pipe components together, each coupling segment comprising
an arcuate body having first and second ends;
first and second bolt pads extending from the first and second ends of the arcuate body, the first and second bolt pads defining fastener openings therethrough for receiving a fastening member; and
a fastener engagement surface defined on the first and second bolt pads, the fastener engagement surface being inclined relative to a horizontal plane such that the head of a fastening device inserted through the openings will apply a greater clamping force on a inner portion of the fastener engagement surface that is located radially inwardly from a center line of the fastener opening than is applied to the portion of the fastener engagement surface that is located radially outwardly from the centerline.

2. The pipe coupling of claim 1, the arcuate body comprising a channel configured to receive a sealing element, the channel defined by an annular channel surface and a pair of flanges extending from annular channel surface.

3. The pipe coupling of claim 2, wherein the flanges comprise upper and lower portions, the upper portion comprising a retainer lip configured to be received in grooves defined in the pipe components to be coupled together.

4. The pipe coupling of claim 3 wherein an inner surface of the retainer lip defines a lead angle and a retainer angle from a vertical plane, wherein the lead angle is greater from the retainer angle.

5. The pipe coupling of claim 4, wherein the lead angle is in the range of about 20 degrees to abut 35 degrees, and the retainer angle in the range of about 2°-10°.

6. The pipe coupling of claim 2, further comprising a seal received in the channel.

7. A pipe coupling comprising:
first and second mating coupling segments, each coupling segment comprising a channel, the channel comprising an annular channel surface and a pair of opposed flanges extending therefrom, wherein the flange includes a retainer lip with a lead portion and a retainer portion, the lead portion and retainer portion being angularly offset from a vertical plane, the lead portion being offset to a greater degree than the retainer portion.

8. The pipe coupling of claim 7, wherein the lead portion is offset in the range of 20 degrees to 35 degrees.

9. The pipe coupling of claim 7, wherein the retainer portion is offset in the range of about 2 degrees to about 10 degrees.

10. The pipe coupling of claim 7, the coupling segments further comprising a pair of bolt pads defining bolt openings therethrough and configured to receive bolts to connect the first and second coupling segments together.

11. The pipe coupling of claim 10, the bolt pads comprising bolt engagement surfaces, the bolt engagement surfaces being angularly offset from a horizontal plane.

12. The pipe coupling of claim 11, wherein the bolt engagement surfaces are angularly offset in the range of about 2° to about 5° from the horizontal.

13. The pipe coupling of claim 11, wherein a bolt head tightened into the bolt engagement surface will apply a greater clamping force on a portion of the engagement surface located radially inwardly from a line bisecting the bolt opening than on a portion of the bolt engagement surface located radially outwardly therefrom.

14. A pipe assembly comprising:
first and second grooved pipe components; and
a coupling connecting the first and second grooved pipe components in an end-to-end relationship, the coupling comprising first and second arcuate coupling segments, each coupling segment comprising:
a channel comprising an annular channel surface and first and second flanges extending therefrom; and
a retainer lip defined on the flanges configured to be received in grooves on the first and second grooved pipe components, the retainer lip having a stepped inner surface, the stepped inner surface defining a lead portion at the leading edge of the retainer lip and a retainer portion extending from the annular channel surface, the lead portion extending from and angularly offset from the retainer portion, wherein a lead angle defined by the lead portion is greater than a retainer angle defined by the retainer portion.

15. The pipe assembly of claim 14, the coupling segments further comprising bolt pads configured to receive bolts and connect the coupling segments, the bolt pads having inclined engagement surfaces such that bolts connecting the coupling segments apply a greater clamping force to a radially inward portion of the engagement surface than a force applied on a radially outward portion.

16. The pipe assembly of claim 14, wherein the lead angle is in the range of about 20° to 35°.

17. The pipe assembly of claim 16, wherein the retainer angle is in the range of about 2° to about 10°.

18. A pipe coupling comprising:
a pair of coupling segments, each coupling segment comprising a channel defined by an annular channel surface and a pair of opposed flanges extending therefrom;
a seal configured for insertion into the channel, the seal comprising:
a seal body;
a pair of opposed flanges extending from the seal body and defining a space therebetween; and
a cut shield positioned in the space between the flanges.

19. The coupling of claim 18, wherein the cut shield is an annular ring.

20. The coupling of claim 18, wherein the cut shield is formed from a high density polyethylene.

21. A pipe assembly comprising first and second pipe components, the coupling of claim 18 connecting the pipe components in end-to-end relationship.
